(19) United States
(12) Patent Application Publication
(10) Pub. No.: US 2012/0158442 A1
(43) Pub. Date: Jun. 21, 2012

(54) SYSTEMS AND METHODS FOR GENERATING A DYNAMIC OPTIMAL TRAVEL SOLUTION

(75) Inventors: Christa R. Ancri, Potomac, MD (US); Michael Givens, Phoenix, AZ (US); Satyendra Hiredesai, Phoenix, AZ (US); Prashant Lodha, Phoenix, AZ (US); Matthew Scott Love, Allentown, PA (US); Frank E. Schnur, Hopkinton, MA (US); Sangita R. Shah, Middlesex (GB)

(73) Assignee: American Express Travel Related Services Company, Inc., New York, NY (US)

(21) Appl. No.: 12/970,511

(22) Filed: Dec. 16, 2010

(51) Int. Cl. G06Q 10/00

(52) U.S. Cl. 705/5; 705/1.1

(57) ABSTRACT

A system and method for generating a dynamic optimal travel solution is disclosed. The method includes receiving an optimal travel solution and receiving consumption data, wherein the consumption data includes an actual market share. The method also includes receiving quality of service index data (QSI), wherein the QSI includes a maximum realistic market share, and generating a dynamic optimal travel solution, in response to the optimal travel solution, the consumption data, and the QSI.

### BACKGROUND

1. Field of the Invention

The present disclosure generally relates to generating a dynamic optimal travel solution.

2. Related Art

An organization may purchase travel services from greater than a single travel carrier. For example, an organization may have offices, distribution centers and manufacturing facilities across a variety of locations, and the employees of such an organization may be expected to travel frequently between one or more of the organization's offices in the normal course of business. In these circumstances, it is common for an organization to negotiate incentive/discount arrangements with a variety of travel carriers in return for agreement by the organization to source a portion of its travel needs through each carrier.

Occasionally, an organization may not benefit from an agreement with a travel carrier. For instance, an organization may agree to use a particular carrier to travel between a city pair, e.g., between city A and city B. In so doing, the organization may incur a long delay where, for example, the carrier it has contracted with to service the described route offers infrequent or limited service between the city pair. In another example, an agreement with one carrier may actually force the organization to ignore a less costly alternative through a different carrier.

In light of these obstacles, tools (e.g., computer modeling software tools) have been developed to assist in the optimization of corporate travel plans. However, in the past, these tools have not been responsive in real-time to changes in corporate and/or carrier needs, availability, pricing, supply, demand, and the like. Indeed, past systems have been unable to optimize and re-optimize a travel solution in real-time, and have been based at least partially upon a variety of internal and external variables. Moreover, some prior art systems have been unable to optimize a travel solution based at least partially upon a large number of variables—e.g., greater than a small number of travel carriers (e.g., two carriers) and/or city pairs/markets (e.g., one hundred city pairs/markets).

Thus, a system and method capable of optimizing a travel solution in real time or pseudo-real time (i.e., real time delayed by a small processing interval) would be very beneficial. Further, a system and method capable of accepting a large number of travel variables would also be beneficial, particularly where that system and method are capable of generating optimum travel solutions in real-time or pseudo-real time.

### SUMMARY

The present disclosure includes a system, method, and article for generating a dynamic optimal travel solution. The method includes receiving an optimal travel solution and receiving consumption data, wherein the consumption data includes an actual market share. The method also includes receiving quality of service index (QSI) data, wherein the QSI includes a maximum realistic market share, and generating a dynamic optimal travel solution, in response to the optimal travel solution, the consumption data, and the QSI. The method may also include transmitting the dynamic optimal travel solution to a client. The actual market share may comprise a plurality of travel reservations for an organization, that are purchased through a travel carrier. The maximum realistic market share may comprise a plurality of travel reservations, beyond which a travel carrier is unable to make accommodations. The value associated with the dynamic optimal travel solution may be reduced as a result of the QSI indicating that a travel carrier will be unable to satisfy the dynamic optimal travel solution.

In another embodiment, generating a dynamic optimal travel solution may further comprise comparing the consumption data to the optimal travel solution, and adjusting a value associated with the optimal travel solution based at least partially upon the consumption data. In another embodiment, generating a dynamic optimal travel solution may further comprise comparing the dynamic optimal travel solution to the QSI and adjusting a value associated with the dynamic optimal travel solution based at least partially upon the QSI.

### BRIEF DESCRIPTION OF THE DRAWINGS

The features and advantages of the present disclosure will become more apparent from the detailed description set forth below when taken in conjunction with the drawings, wherein like numbers refer to like elements.

FIG. 1 shows an exemplary system diagram, in accordance with an embodiment.

FIG. 2 shows a flowchart depicting an exemplary method for generating a dynamic optimal travel solution.

FIG. 3 shows an exemplary optimal travel solution.

FIG. 4 shows exemplary consumption data.

FIG. 5 shows exemplary quality of service index (QSI) data.

FIG. 6 shows an exemplary dynamic optimal travel solution.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Phrases and terms similar to “financial institution,” “transaction account issuer,” and “payment processor” may include any person, entity, software and/or hardware that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business”, “merchant”, “supplier” or “seller” may be used interchangeably with each other and shall mean any person, entity, distributor system, software and/or hardware that is a provider, broker and/or any other entity in the distribution chain of goods or services and/or that receives payment or other consideration. For example, a merchant may be a grocery store, a retail store, a travel agency, a service provider, an on-line merchant or the like. For example, a supplier may request payment for goods sold to a buyer who holds an account with a transaction account issuer.

The terms “payment vehicle,” “financial transaction instrument,” “transaction instrument,” “transaction account product” and/or the plural form of these terms may be used interchangeably throughout to refer to a financial instrument. As used herein, an account code may or may not be associated with a physical financial instrument.

Phrases and terms similar to a “buyer,” “consumer,” and “user” may include any person, entity, software and/or hardware that receives items in exchange for consideration (e.g. financial payment). For example, a buyer may purchase, lease, rent, barter or otherwise obtain items from a supplier and pay the supplier using a transaction account.

Phrases and terms similar to an “item” may include any good, service, information, experience, reward, points, coupons, credits, monetary equivalent, anything of value, something of minimal or no value, etc.

Phrases or terms similar to a “processor” (such as a payment processor) may include a company (e.g., a third party) appointed (e.g., by a merchant) to handle transactions for merchant banks. Processors may be broken down into two types: front-end and back-end. Front-end processors have connections to various transaction accounts and supply authorization and settlement services to the merchant banks' merchants. Back-end processors accept settlements from front-end processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases or terms similar to a “payment gateway” or “gateway” may include an application service provider that authorizes payments for e-businesses, online retailers, and/or traditional brick and mortar merchants. A payment gateway may protect transaction account details by encrypting sensitive information, such as transaction account numbers, to ensure that information passes securely between the customer and the merchant and also between merchant and payment processor.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases or terms similar to “transaction account” may include any account that may be used to facilitate a financial transaction. A “transaction account” as used herein refers to an account associated with an open account or a closed account system (as described herein). The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account”, “account code”, or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account code may be distributed and stored in any form of plastic, electronic, magnetic, radio frequency, wireless, audio and/or optical device capable of transmitting or downloading data from itself to a second device. A customer account code may be, for example, a sixteen-digit transaction account code, although each transaction account provider has its own numbering system, such as the fifteen-digit numbering system used by American Express. Each company's transaction account codes comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account code may be, for example, any number or alpha-numeric characters that identify a particular merchant for purposes of card acceptance, account reconciliation, reporting, or the like.

It should be noted that the transfer of information in accordance with the present disclosure, may be completed in a format recognizable by a merchant system or account issuer. In that regard, by way of example, the information may be transmitted from an RFID device to an RFID reader or from the RFID reader to the merchant system in magnetic stripe or multi-track magnetic stripe format.

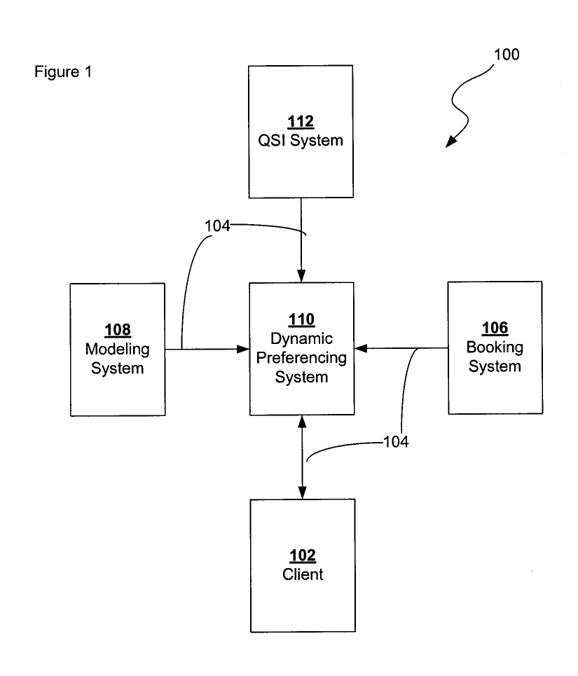

Referring to FIG. 1, system 100 implements a method for dynamically optimizing a travel solution. System 100 may include a client 102, a network 104, a booking system 106, a modeling system 108, a dynamic preferencing system 110, and a quality of service index (“QSI”) system 112. System 100 may include a variety of other components, including for example, one or more mobile gateway servers (not shown) for securely receiving and transmitting data to and from the client 102, one or more electronic commerce website servers (not shown), and/or one or more payment processor authorization gateway servers (not shown).

Client 102 may comprise any software and/or hardware suitably configured for sending and/or receiving data. Client 102 may include a personal computer such as a desktop or laptop computer, an iPad, iMAC, or MacBook, or, generally, any of a wide array of personal computing products. Client 102 may further comprise a kiosk, a terminal, a point of sale (POS) device, a television, a digital sign or banner, or any other device capable of sending and/or receiving data over a network. In an embodiment, client 102 may run Microsoft Internet Explorer, Mozilla Firefox, Google Chrome, Apple Safari, or any other of the myriad software packages available for browsing the internet. Client 102 may further comprise, at least, a display, such as a liquid crystal display (LCD), or a plasma screen display. Client 102 may further comprise a mobile communication device, such as a smart phone (e.g., an iPhone, Blackberry, Droid device, and/or the like) and/or a personal digital assistant (PDA).

Network 104 may comprise software and/or hardware suitably configured or configurable to facilitate the transmission and/or reception of data. Thus, network 104 may comprise any of a variety of wired and/or wireless network architectures, including, but not limited to, an RF network architecture such as a network associated with a wireless provider (e.g, a 3G or 4G network), a Wi-Fi network architecture (e.g., a home area or local area network), and/or a wired network architecture reliant upon one or more cables and/or trunk lines and/or optical fibre lines.

Booking system 106 may comprise software and/or hardware suitably configured or configurable to receive and/or process data. Thus, booking system 106 may comprise any type of computer server configured or configurable to host a database. In an embodiment, booking system 106 may comprise a rack mountable server appliance running a suitable server operating system (e.g., IIS) and having database software (e.g., Oracle) installed thereon. In an embodiment, booking system 106 may host a database comprising booking data associated with travel itineraries.

Modeling system 108 may comprise software and/or hardware suitably configured or configurable to receive and/or process data. Thus, modeling system 108 may comprise any type of computer server and/or a computer server configured or configurable to host a database. In an embodiment, modeling system 108 may comprise a rack mountable server appliance running a suitable server operating system (e.g., IIS) and having database software (e.g., Oracle) installed thereon. In an embodiment, modeling system 108 may comprise the system (or a system similar to the system) described in U.S. Pat. No. 5,832,453, filed Mar. 22, 1994, which is hereby incorporated by reference.

Dynamic preferencing system 110 may comprise software and/or hardware suitably configured or configurable to receive and/or process data. Thus, dynamic preferencing system 110 may comprise any type of computer server and/or a computer server configured or configurable to host a database. In an embodiment, dynamic preferencing system 110 may comprise a rack mountable server appliance running a suitable server operating system (e.g., IIS) and having database software (e.g., Oracle) installed thereon.

QSI system 112 may comprise software and/or hardware suitably configured or configurable to receive and/or process data. Thus, QSI system 112 may comprise any type of computer server and/or a computer server configured or configurable to host a database. In an embodiment, QSI system 112 may comprise a rack mountable server appliance running a suitable server operating system (e.g., IIS) and having database software (e.g., Oracle) installed thereon. In an embodiment, QSI system 112 may comprise data related to the realistic ability of one or more travel carriers to meet service obligations and/or to serve a market.

Client 102, booking system 106, modeling system 108, dynamic preferencing system, QSI system 112, and/or any combination thereof may be coupled by network 104. In this regard, each of client 102, booking system 106, modeling system 108, dynamic preferencing system 110, and QSI system 112 may transmit and/or receive data to and from, respectively, any of the systems to which they are or may be coupled.

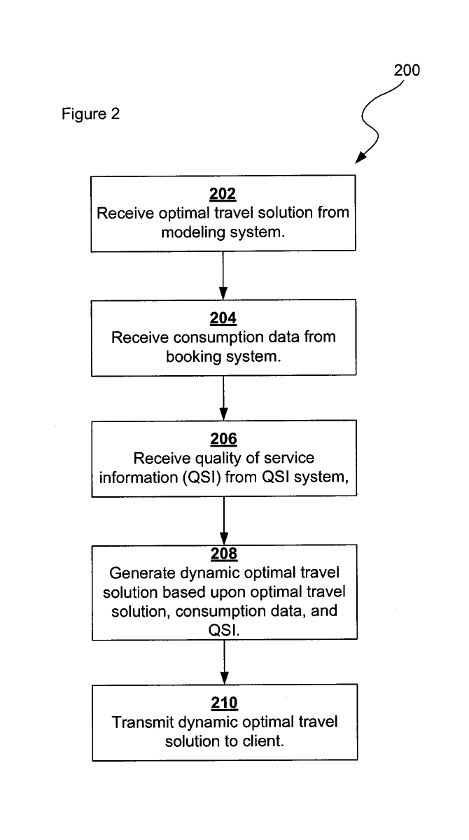

Referring to FIG. 2, a method 200 for dynamically optimizing a travel solution is described. In an embodiment, a dynamic preferencing system 110 may receive an optimal travel solution from a modeling system 108 (step 202), such as, for example, a modeling system 108 identical or similar to the system described in U.S. Pat. No. 5,832,453, which is incorporated by reference above. A travel solution may be optimized for a variety of travel carriers, including for example, one or more airlines, one or more railways, one or more cruise lines, and the like. As those skilled in the art will appreciate, most often, particularly where large organizations are concerned, a travel solution may be optimized for one or more airlines.

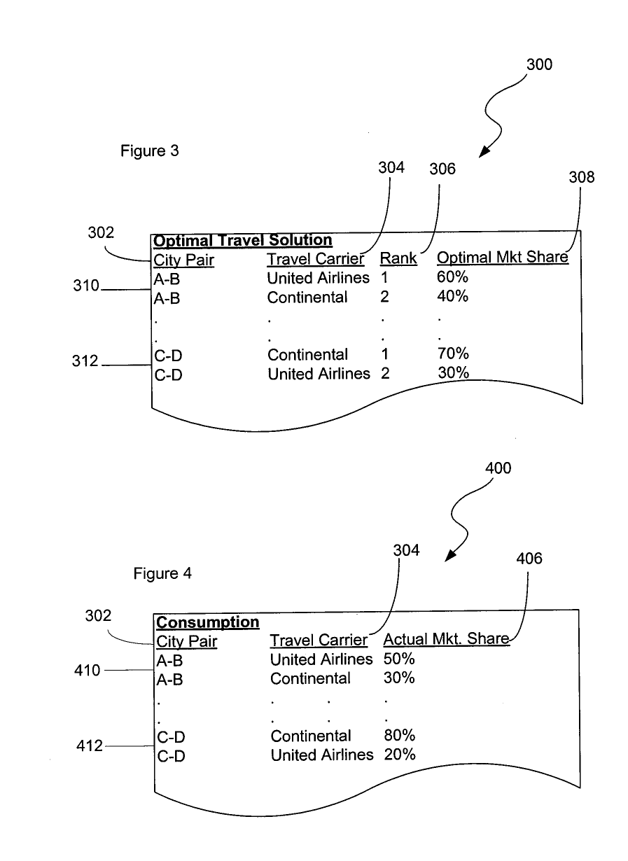

An exemplary optimal travel solution 300 is depicted with reference to FIG. 3. In an embodiment, an optimal travel solution may comprise an origin-destination city pair 302, one or more travel carriers 304, a rank 306, and/or an optimal market share 308 associated with each travel carrier. An optimal market share 308 may be indicative of a number or percentage of travel tickets that an organization should purchase through a particular travel carrier 304 for a given city pair 302 in order to optimize (i.e., minimize) its travel expenses. In an embodiment, an optimal travel solution 300 may include a first city pair 310 and a second city pair 312. The first city pair 310 may be associated with one or more travel carriers 304, each of which may offer services between the first city pair 310. Likewise, the second city pair 312 may be associated with one or more travel carriers 304, each of which may offer services between the second city pair 312. Each travel carrier 304 offering services between a city pair 302 may be ranked (and associated with a rank 306) based at least partially upon an optimal market share 308 associated with the travel carrier 304 and city pair 302.

For instance, and with reference to FIG. 3, city pair 310 A-B may be served by two travel carriers 304, United Airlines and Continental. Each travel carrier 304 may be assigned a rank 306 with respect to one or more city pairs 302 based at least partially upon an optimal market share 308 associated with the travel carrier 304. Thus, United Airlines may receive a rank 306 of “1” with respect to city pair 310 A-B and a rank of “2” with respect to city pair 312 C-D, based at least partially upon a greatest (or greater) optimal market share of 60% for city pair 310 A-B and a least (or lesser) optimal market share of 30% for city pair 312 C-D. In other words, a ranking 306 may indicate a relative position of a travel carrier's optimal market share 308 for a given city pair 302. In an embodiment, no ranking 306 is provided. In an embodiment, no optimal market share 308 is provided.

Returning to FIG. 2, dynamic preferencing system 110 may further receive booking or consumption data from a booking system 106 (step 204). Exemplary consumption data 400 is depicted with reference to FIG. 4. Consumption data 400 may comprise actual booking data associated with an organization's/corporation's travel activities. In an embodiment, and similar to the optimal travel solution 300, consumption data 400 may comprise one or more origin-destination city pairs 302, one or more travel carriers 304, and an actual market share 406 associated with each city pair 302 and travel carrier 404 combination. Thus, for example, consumption data 400 may show a first city pair 410 and a second city pair 412. The first city pair 410 may be associated with one or more travel carriers, each of which may offer services between the first city pair 410. Likewise, the second city pair 412 may be associated with one or more travel carriers, each of which may offer services between the second city pair 412. Each travel carrier 304 offering services between a city pair 302 may be associated with an actual market share 406 for each city pair 302. The actual market share 406 may show a number or percentage of tickets between each city pair 302 that an organization has sourced through a particular travel carrier 304. Thus, in the example of FIG. 4, United Airlines may account for 50% of an organization's travel between city pair 410 A-B and 20% of the organization's travel between city pair 412 C-D. Similarly, Continental Airlines may account for 30% of an organization's travel between city pair 410 A-B and 80% of the organization's travel between city pair 412 C-D. As described above with reference to FIG. 3, each travel carrier 304 and city pair 302 combination may be associated with a rank (not shown). In some embodiments, no rank is provided. However, where a rank is included, it may represent a relative position of a travel carrier's 304 actual market share 406 for each city pair 302.

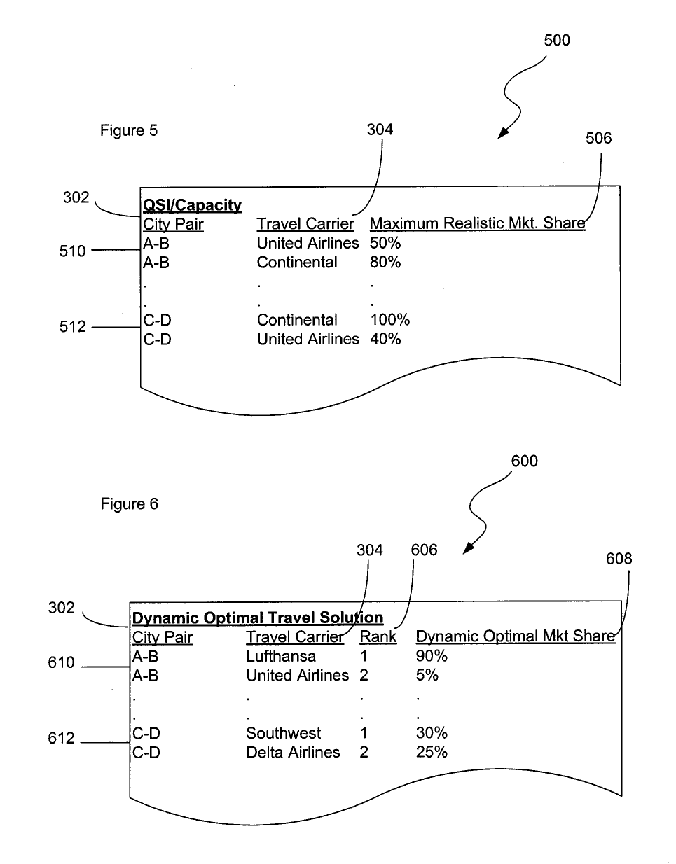

Returning again to FIG. 2, dynamic preferencing system 110 may further receive QSI or capacity data from QSI system 112. Exemplary QSI 500 is depicted with reference to FIG. 5. QSI 500 may comprise data associated with a travel carrier's 304 realistic ability to service a city pair 302. In an embodiment, and similar to the optimal travel solution 300, QSI may comprise one or more origin-destination city pairs 302, one or more travel carriers 304, and a maximum realistic market share 506 associated with each city pair 302 and travel carrier 304. Thus, for example, QSI 500 may show a first city pair 510 and a second city pair 512. The first city pair 510 may be associated with one or more travel carriers 304, each of which may offer services between the first city pair 510. Likewise, the second city pair 512 may be associated with one or more travel carriers 304, each of which may offer services between the second city pair 512. Each travel carrier 304 offering services between a city pair 302 may be associated with a maximum realistic market share 506 for each city pair 302. The maximum realistic market share 506 may show a percentage or number associated with a travel carrier's maximum realistic ability to service a city pair 302. A travel carrier's maximum realistic ability to service a city pair 302 may be affected by factors including, but not limited to, the number and size of aircraft available to the travel carrier 304, time of day/month/year, the price of fuel, and the like. Thus, in the example of FIG. 5, United Airlines may have the capacity to service 50% of an organization's travel between city pair 510 A-B and 40% of the organization's travel between city pair 512 C-D. Similarly, Continental Airlines may have the capacity to service 80% of an organization's travel between city pair 510 A-B and 100% of the organization's travel between city pair 502 C-D. As described above with reference to FIG. 3, each travel carrier 304 and city pair 302 may be associated with a rank (not shown). In some embodiments, no rank is provided. However, where a rank is included, it may represent a relative position of a travel carrier's 304 maximum realistic market share 506 for each city pair 302.

Returning once more to FIG. 2, dynamic preferencing system 110 may be configured or configurable to process the data received from booking system 106, modeling system 108, and QSI system 112. That is, dynamic preferencing system 110 may process the optimal travel solution 300, the consumption data 400, and the QSI 500 to produce a dynamic optimal travel solution 600 (step 208) (see FIG. 6). Dynamic preferencing system 110 may process this data in response to a request from client 102 for a dynamic optimal travel solution 600. In an embodiment, dynamic preferencing system 110 may process the data received from booking system 106, modeling system 108, and QSI system 112 automatically, or during predetermined intervals.

A dynamic optimal travel solution 600 may comprise a modified version of optimal travel solution 300. More particularly, a dynamic optimal travel solution 600 may comprise the optimal travel solution adjusted or modified in view of QSI 500 and consumption data 400. A dynamic optimal travel solution 600 may be adjusted in real time or pseudo-real time (i.e., real time delayed by a processing interval). A dynamic optimal travel solution 600 may also be adjusted at predefined or specifically defined intervals (e.g., once per hour, once per day, once per week, etc).

An exemplary dynamic optimal travel solution 600 is depicted with reference to FIG. 6. In an embodiment, and similar to the optimal travel solution 300, a dynamic optimal travel solution 600 may comprise one or more origin-destination city pairs 302, one or more travel carriers 304, and a dynamic optimal market share 608 associated with each city pair 302 and travel carrier 304. Thus, for example, dynamic optimal travel solution 600 may include a first city pair 610 and a second city pair 612. The first city pair 610 may be associated with one or more travel carriers 304, each of which may offer services between the first city pair 610. Likewise, the second city pair 612 may be associated with one or more travel carriers 304, each of which may offer services between the second city pair 612. Each travel carrier 304 offering services between a city pair 302 may be associated with a dynamic optimal market share 608 for each city pair 302. Further, as described above with reference to FIG. 3, each travel carrier 304 and city pair 302 may be associated with a rank (not shown). In some embodiments, no rank is provided. However, where a rank is included, it may represent a relative position of a travel carrier's 304 dynamic optimal market share 608 for each city pair 302.

In an embodiment, a dynamic optimal travel solution 600 may be generated as follows. Dynamic preferencing system 110 may compare consumption data 400 to the optimal travel solution 300. This comparison may be performed in real time, pseudo-real time, a delayed time, period or any other time period. The comparison may also be performed at predefined or specifically defined intervals (e.g., once per hour, once per day, once per week, etc.) Where the consumption data 400 does not match or align satisfactorily (see below with reference to tolerance values) with the optimal solution 300, dynamic preferencing system 110 may output a dynamic optimal travel solution 600 that specifies an increase or decrease in purchasing from one or more travel carriers 304 and one or more city pairs 302. Thus, for example, if the optimal travel solution 300 specifies that United Airlines should serve 60% of the market share for city pair 310 A-B, but consumption data 400 indicates that United Airlines currently serves only 50% of an organization's travel needs between city pair 310 A-B, dynamic preferencing system 110 may adjust the dynamic optimal travel solution 600 to indicate that an increase in purchases from United Airlines for flights between city pair 310 A-B is in order. Dynamic preferencing server 110 may impose or suggest this increase for a duration sufficient to bring actual consumption data 400 in line with the optimal travel solution 300.

Dynamic preferencing system 110 may receive a tolerance value (not shown). A tolerance value may be received from client 102, or from any other device or system that is coupled or may be coupled to dynamic preferencing system 110. A tolerance value may represent a tolerance or margin within which an organization may not wish dynamic preferencing system 110 to adjust the dynamic optimal travel solution 600. For instance, an organization may specify a tolerance value of 5%. In response to a 5% (or less) tolerance value, dynamic preferencing system 110 will not make adjustments to the organization's travel ticket purchasing activity. However, should an organization's consumption data 400 vary outside of a specified tolerance value (e.g., 5%), dynamic preferencing system 110 may adjust the dynamic optimal travel solution 600 to bring the optimal travel solution 300 within 5% of the consumption data 400.

Dynamic preferencing system 110 may further compare the dynamic optimal travel solution 600 and/or the optimal travel solution 300 to QSI 500. In response to this comparison, dynamic preferencing system 110 may determine that the dynamic optimal travel solution 600 may not be attained, or may only be attained very slowly. Either of these possibilities may occur, for example, as a result of a travel carrier's 304 inability to serve a city pair 302 at an optimal rate (i.e., at a rate specified by the optimal travel solution 300), or as a result of the fact that a travel carrier's 304 actual market share 406 is the same as or very close to the travel carrier's maximum realistic market share 506 (in which case, only very small increases in a travel carrier's actual market share 406 will be possible, thereby limiting the rate at which dynamic preferencing system 110 is able to upwardly adjust the actual market share 406). Thus, a travel carrier's maximum realistic market share 506 may act as a cap on the ability of dynamic preferencing system 110 to bring the travel carrier's actual market share 406 in line with the dynamic optimal travel solution 600 and/or the optimal travel solution 300. The maximum realistic market share 506 may also assist dynamic preferencing system 110 in realizing, to the fullest extent possible, the optimal travel solution 300. That is, in the absence of a maximum realistic market share 506, the dynamic optimal travel solution 600 might include impossibly high dynamic optimal market share values 608, in which case, dynamic preferencing system 110 would be unable to achieve a best solution. This would occur by virtue of the fact that dynamic preferencing system 110 would not, in fact, make any adjustments to the dynamic optimal travel solution 600, even where the solution 600 included one or more impossible dynamic optimal market share values 608. The inclusion of the maximum realistic market share value 506 therefore permits dynamic preferencing system 110 to make adjustments to the dynamic optimal travel solution 600 based at least partially upon data about a travel carrier's 304 abilities and inabilities in the real world.

After generating a dynamic optimal travel solution 600, dynamic preferencing system 110 may transmit one or more of the dynamic optimal travel solution 600, the optimal travel solution 300, the consumption data 400, and/or the QSI 500 to client 102. An organization employee, travel agent/agency, and the like may interact with client 102 to view and/or request changes to the data provided by dynamic preferencing system 110. Client 102 may also be used to make travel reservations in compliance (or out of compliance) with the dynamic optimal travel solution 600. In an embodiment, an employee of an organization may input one or more travel requests by way of client 102. Client 102 may retrieve a dynamic optimal travel solution 600, and select for the employee one or more optimal travel itineraries based at least partially upon the dynamic optimal travel solution 600. In another embodiment, an employee may input one or more travel requests at client 102. However, client 102 may not process the travel requests in accordance with a dynamic optimal travel solution 600. Rather, client 102 may transmit the one or more travel requests to dynamic preferencing system 110, or to another backend system (not shown) coupled thereto. Dynamic preferencing system 110 or the other backend system may process the one or more travel requests based at least partially upon a dynamic optimal travel solution 600, making reservations as needed. Thus, one or more travel reservations may be completed on a client side and/or on a server side.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in certain embodiments.

In various embodiments, the methods described herein are implemented using the various particular machines described herein. The methods described herein may be implemented using the particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, 95/98/2000, XP, Vista, OS2, UNIX, Linux, Solaris, MacOS, etc.) as well as various conventional support software and drivers typically associated with computers. A user may include any individual, business, entity, government organization, software and/or hardware that interact with a system.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data _{—} associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

A firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Peri, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, machine, hardware, software or business. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIG. 2, the process flow depicted is merely an embodiment and is not intended to limit the scope of the invention as described herein. For example, the steps recited in any of the method or process descriptions may be executed in any order and are not limited to the order presented. It will be appreciated that the following description makes appropriate references not only to the steps and user interface elements depicted in FIG. 2, but also to the various system components as described above with reference to FIG. 1.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the invention has been described as a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a computer-based system for dynamically optimizing a travel solution, an optimal travel solution;
receiving, by the computer-based system, consumption data, wherein the consumption data includes an actual market share;
receiving, by the computer-based system, quality of service index data (QSI), wherein the QSI includes a maximum realistic market share; and
generating, by the computer-based system, a dynamic optimal travel solution, based at least partially upon the optimal travel solution, the consumption data, and the QSI.

2. The method of claim 1, further comprising transmitting, by the computer-based system, the dynamic optimal travel solution to a client.

3. The method of claim 1, wherein the actual market share comprises a plurality of travel reservations for an organization, that are purchased through a travel carrier.

4. The method of claim 1, wherein the maximum realistic market share comprises a plurality of travel reservations, beyond which a travel carrier is unable to make accommodations.

5. The method of claim 1, wherein the generating further comprises:
comparing, by the computer-based system, the consumption data to the optimal travel solution; and
adjusting, by the computer-based system, a value associated with the optimal travel solution based at least partially upon the consumption data.

6. The method of claim 1, wherein the generating further comprises:
comparing, by the computer-based system, the dynamic optimal travel solution to the QSI; and
adjusting, by the computer-based system, a value associated with the dynamic optimal travel solution based at least partially upon the QSI.

7. The method of claim 6, wherein the value associated with the dynamic optimal travel solution is reduced as a result of the QSI indicating that a travel carrier will be unable to satisfy the dynamic optimal travel solution:

8. An article of manufacture including a non-transitory, tangible computer readable medium having instructions stored thereon that, in response to execution by a computer-based system for dynamically optimizing a travel solution, cause the computer-based system to perform operations comprising:
receiving, by the computer-based system, an optimal travel solution;
receiving, by the computer-based system, consumption data, wherein the consumption data includes an actual market share;
receiving, by the computer-based system, quality of service index data (QSI), wherein the QSI includes a maximum realistic market share;
generating, by the computer-based system, a dynamic optimal travel solution based at least partially upon the optimal travel solution, the consumption data, and the QSI.

9. The article of claim 8, wherein the actual market share comprises a plurality of travel reservations for an organization, that are purchased through a travel carrier.

10. The article of claim 8, wherein the maximum realistic market share comprises a plurality of travel reservations, beyond which a travel carrier is unable to make accommodations.

11. The article of claim 8, wherein the generating further comprises:
comparing, by the computer-based system, the consumption data to the optimal travel solution; and
adjusting, by the computer-based system, a value associated with the optimal travel solution based at least partially upon the consumption data.

12. The article of claim 8, wherein the generating further comprises:
comparing, by the computer-based system, the dynamic optimal travel solution to the QSI; and
adjusting, by the computer-based system, a value associated with the dynamic optimal travel solution based at least partially upon the QSI.

13. The article of claim 12, wherein the value associated with the dynamic optimal travel solution is reduced as a result of the QSI indicating that a travel carrier will be unable to satisfy the dynamic optimal travel solution.

14. A system comprising:
a tangible, non-transitory memory communicating with a processor for optimizing a travel solution,
the tangible, non-transitory memory having instructions stored thereon that, in response to execution by the processor, cause the processor to perform operations comprising:
receiving, by the processor, an optimal travel solution;
receiving, by the processor, consumption data, wherein the consumption data includes an actual market share;
receiving, by the processor, quality of service index data (QSI), wherein the QSI includes a maximum realistic market share;
generating, by the processor, a dynamic optimal travel solution, based at least partially upon the optimal travel solution, the consumption data, and the QSI.

15. The system of claim 14, wherein the processor further performs operations comprising transmitting, by the computer-based system, the dynamic optimal travel solution to a client.

16. The system of claim 14, wherein the actual market share comprises a plurality of travel reservations for an organization, that are purchased through a travel carrier.

17. The system of claim 14, wherein the maximum realistic market share comprises a plurality of travel reservations beyond which a travel carrier is unable to make accommodations.

18. The system of claim 14, wherein the generating further comprises:
comparing, by the computer-based system, the consumption data to the optimal travel solution; and
adjusting, by the computer-based system, a value associated with the optimal travel solution based at least partially upon the consumption data.

19. The system of claim 14, wherein the generating further comprises:
comparing, by the computer-based system, the dynamic optimal travel solution to the QSI; and
adjusting, by the computer-based system, a value associated with the dynamic optimal travel solution based at least partially upon the QSI.

20. The system of claim 19, wherein the value associated with the dynamic optimal travel solution is reduced as a result of the QSI indicating that a travel carrier will be unable to satisfy the dynamic optimal travel solution.
